(19) United States
(12) Patent Application Publication
(10) Pub. No.: US 2012/0308172 A1
(43) Pub. Date: Dec. 6, 2012

(54) DOUBLE ROW, TANDEM, ANGULAR CONTACT, BALL BEARING ASSEMBLY

(75) Inventor: Shakeel SHAIKH, Windsor (CA)

(73) Assignee: Schaeffler Technologies GmbH & Co. KG

(21) Appl. No.: 13/150,761

(22) Filed: Jun. 1, 2011

(51) Int. Cl. F16C 33/38

(52) U.S. Cl. 384/523

(57) ABSTRACT

The double row, tandem, angular contact ball bearing assembly uses snap cages for both rows of ball bearings. The use of snap cages reduces straddle between the rows and allows for improvements in spacing and increased load carrying capacity without increased outer dimensions of the bearing.

### FIELD OF THE INVENTION

The present Invention relates to double row, tandem, angular contact ball bearing assemblies and, especially, tandem ball bearing assemblies construed for use within differential gearings and other applications where high radial and high unidirectional axial rigidity is a requirement.

### BACKGROUND OF THE INVENTION

Depending on the inclination and orientation of the contact angles between the rolling elements and the bearing rings, angular contact ball bearing assemblies are generally grouped into three species which are O-arrangements, X-arrangements, and tandem-arrangements. Each one of these arrangements has its specific purpose and unique design characteristics to solve a particular set of tasks enabling respective specific applications.

Tandem ball bearings are usually designed in a manner wherein the contact angles for the adjacent rows of ball bearings are quite similar. The balls as received within the raceways are guided within respective windows formed by two separate annular window-cages. The distance between both raceways is designed such that the inner rings of the window-cages may not abut against each other. The axial distance between the both raceways is designed to secure a sufficient safety clearance between the inner annular ribs of the cages of both rows. Due to this fact, there exists a design restriction in respect to the selection of ball size for the tandem ball bearing in order to maintain the straddle distance between the cages to avoid the interference of the cages of both the rows. This results in designing the bearing with lower load carrying capacity and large overall bearing width.

Currently, all tandem ball bearing designs use window type cages. A typical cross section of a tandem ball bearing using the window-style cages is illustrated in FIG. 1. As shown in FIG. 1, tandem ball bearing assembly 10 has an outer ring 12, an inner ring 14, two adjacent sets of rolling elements 16 in bearings 10 with contact angles 17, illustrated as 25°. Each set of the rolling elements 16 are housed in a window-type cage 18. The inner rib of window-type cages restricts the size of the bearing assembly due to straddle illustrated in circle 19. As can be seen in FIG. 1, the inner rib of each cage requires safety gap (or clearance to prevent interference) with the other thereby restricting the size of the overall assembly; therefore, limiting the load carrying capacity and envelope size of bearing.

### OBJECT OF THE PRESENT INVENTION

It is an object of the present Invention to create a dual row, tandem, angular contact ball bearing assembly wherein there is enhanced load carrying capacity within the same dimensions.

It is also an object of the present Invention to provide a compact bearing design.

It is a further object of the present Invention, to create a double row, tandem, angular contact ball bearing assembly which provides a high axial and radial load carrying capacity at improved relation to its outer dimensions.

It is a further object of the present Invention to enhance the bearing performance by increasing the load carrying capacity of the bearing and lowering the production related costs.

It is just a further object of the present Invention to reduce the limitations in the selection of ball size within a given bearing envelope size.

These and other objects and advantages of the Invention will become more readily apparent by the following description.

### SUMMARY OF THE INVENTION

The objects of the present Invention are obtained by a particular internal design of the bearing, which allows to axially adhere the balls of the two rows, wherein the saved space may be used to increase the diameter of the balls, or to reduce the overall dimensions of width of the bearing without reducing its load carrying characteristic. The cages are designed so as to open inwardly which allows to design the cages as snap-in cages with balls as the rolling elements. More specifically, the Invention may be defined as a double row, tandem, angular contact, ball bearing assembly comprising:

a one piece outer bearing ring having two adjacent outer races, each of the outer races having a single shoulder, the shoulder of one of the outer races is located adjacent an axial edge of the outer ring and the shoulder of the other of the outer races is located axially inward on the outer ring;

a one piece inner bearing ring having two adjacent inner races, each of the inner races having a single shoulder, the shoulder of one of the inner races is located axially inward on the inner ring and the shoulder of the other of the inner races is located axially adjacent a front edge of the inner ring;

one raceway formed by the one of the outer races opposing the one of the inner races;

another raceway formed by the other of the outer races opposing the other one of the inner races;

one set of balls located in the one raceway;

another set of balls located in the other raceway;

one snap cage housing the one set of balls and another snap cage housing the other set of balls, each of the one and other snap cage having a plurality of thin-walled, cup shaped pockets connected to one another by a single rib, each of the pockets housing one of the balls, the rib of the one cage is mounted adjacent one axial edge of the assembly and the other cage is mounted adjacent the other axial edge of the assembly, and each of the pockets open axially inward of the assembly.

The balls of the two rows thus may adhere each other to just leave a minimum axial space and without being separated or shielded from each other by an annular rib-structure of any of the cages. This minimum axial space may be dimensioned to come close to 0.5 mm.

Preferably, the balls in one set do have the same diameter as the balls in the other set. Alternatively, the balls in one set may have a diameter different from the diameter of the balls in the other set.

The pockets of the cages are such that the balls may snap-fit into the pockets from an axial side entry. Suitably, the cages encircle the ball in an amount of about 240°. Although the cages are open towards the inner shoulders of the bearing rings, the cages may be designed such that the balls are fitted into the pocket from a radial direction without requiring significant elastic deformation of the free inner end sections of the sidewalls of the pockets.

The tandem ball bearing design according to the present Invention is suited as replacement to taper roller bearings in a broad field of applications, especially for differential gearings and pinion axle support. By comparison, tandem ball bearings according to the Invention come at least close to the load carrying capacity of taper roller bearings of similar outer dimension while providing less friction and thus improved mechanical efficiency. A particular achievement of the technical concept for tandem ball bearings according to the present Invention is the enhancement of the bearing load carrying capacity using the same or similar envelop dimensions, or to compact the bearing size (overall width) providing the same load carrying capacity.

In contrast to the conventional constructions, the balls of the two rows are no longer separated by a pair of annular ribs of the so far employed window type cage design. The concept according to the present Invention allows to no longer provide axial space for a pair of independent cage ribs and also does no longer require an axial gap between these ribs of the cages. The construction of both cages of the tandem ball bearings according to the Invention is no longer subject of a restriction of the space requirement of the inner ribs of the conventional cages. The tandem ball bearing according to the present Invention provides a higher load carrying capacity compared to conventional taper roller bearings, it requires less space as conventional bearings of same load carrying capacity and also allows to reduce the ring weight and material related costs.

One of the main advantages of the construction according to the present Invention is to enhance the design and capacity of tandem ball bearing by using cages similar to the so called TVH-type cages. Using those cages similar to TVH-type cages avoids the restriction to maintain a quite considerable distance between two rows. The advantages using the TVH-type cages are:

almost no restriction for the distance between the two rows within the same envelop dimensions;

broadening of the option to select larger ball size;

achieving higher load carrying capacity of the bearing within the same envelope dimensions;

higher bearing life;

with higher load carrying capacity design the overall width of the bearing can be reduced (This is due to reducing the distance between the two rows. Assuming 0.5 mm of minimum gap maintained between two balls extreme ends)

more compact bearing design;

overall bearing cost will be reduced since the use of larger balls in the design will reduce the wall thickness of the outer ring and inner ring races and ultimately the cost of the tubes or forgings used for the outer ring and inner ring;

cost savings due to reduced material consumption of cages.

By adopting a cage design similar to the TVH-type cage design it will be possible to select a larger ball size since there is no restriction to keep an axial gap between the inner annular ribs of the cages (The only restriction is, that the balls of both the rows do not interfere each other, while a minimum gap of 0.5 mm between the axial face sections of balls between the two rows is assumed as sufficient). This extremely narrow gab is sufficient, as the balls are stably guided in their races and thus do not have that much axial play as window-type cages would take.

### BRIEF DESCRIPTION OF THE DRAWINGS

These and other aspects of the present Invention may be become further and even more readily apparent by reference to one or more of the following drawings presented herein for purpose of illustration, wherein:

FIG. 1 illustrates a conventional tandem ball bearing assembly;

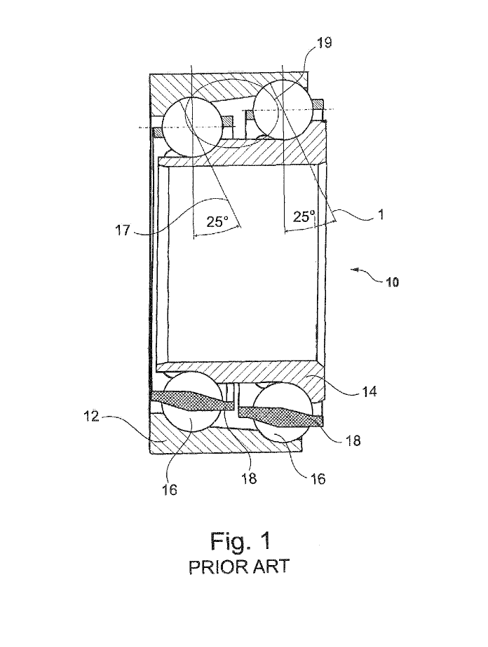

FIG. 2 illustrates a tandem ball bearing similar to the present Invention with increased load capacity;

FIG. 3 illustrates the tandem ball bearing assembly according to the present Invention having compact design;

FIG. 4 illustrates a snap-in cage for use in the present Invention;

FIG. 5 shows a cross section of the cage of FIG. 4 taken along lines V V;

FIG. 6 shows a perspective view of the snap-in cage; and

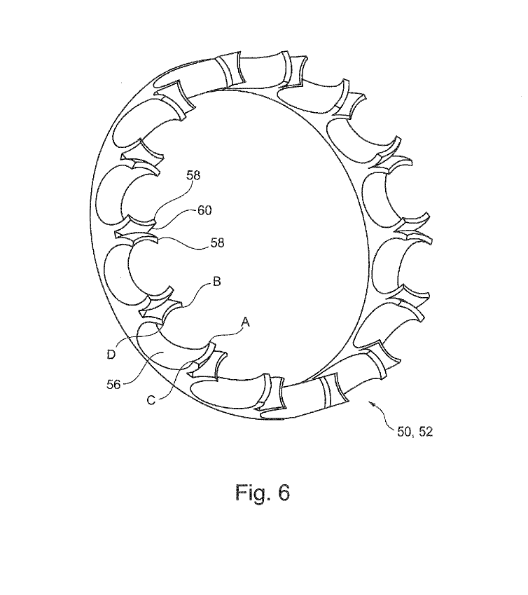

FIG. 7 shows an exploded view of a bearing assembly according to the present invention.

### DETAILED DESCRIPTION OF THE INVENTION

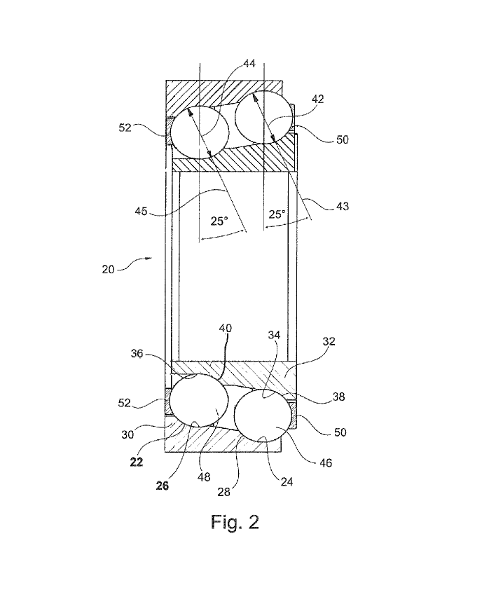

FIG. 2 illustrates a tandem ball bearing assembly 20 for the present Invention having an outer ring 22 with adjacent outer races 24 and 26. Each outer race 24, 26 is limited in axial direction by a respective shoulder 28 and 30.

The outer ring 22 has a first shoulder 30 located axially adjacent the side edge of outer ring 22 and a second shoulder 28 located axially inward on the inner circumferential wall of the outer ring 22.

The outer circumferential wall of the inner ring 32 is shaped to provide inner races 34 and 36. Each inner race 34, 36 is limited by a first shoulder 38 and a second shoulder 40, respectively. Shoulder 38 is located axially adjacent the side edge of inner ring 32 while shoulder 40 is located axially inward on the inner ring 32.

Outer race 24 and inner race 34 define a raceway 42 with a contact angle 43. Outer race 26 and inner race 36 do define a raceway 44 with contact angle 45. A first set of balls 46 is located in raceway 42 while another, i.e. a second set of balls 48 is located in raceway 44. One snap cage 50 holds balls 46 and another snap cage 52 holds balls 48.

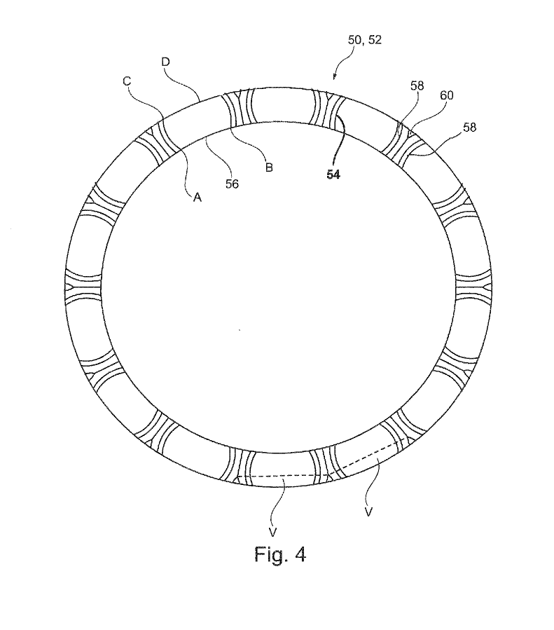

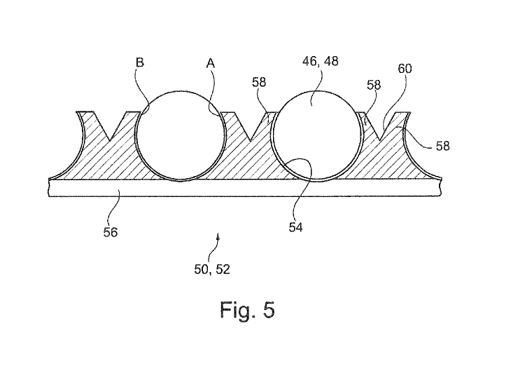

FIGS. 4 and 5 illustrate snap cages 50 and 52. Snap cages 50 and 52 each have pockets 54 connected by an annular rib 56. Each of the pockets 54 has side walls 58 which are separated by a free space 60. Balls 46, 48 are illustrated as snapped into snap cage 50, 52 in FIG. 5. As shown in FIG. 4, each of the pockets 54 has sidewalls 58 which are rounded concave as shown by edges A, B, C and D in order to snap fit balls 46, 48 into the respective pocket 54. Side walls 58 encircle balls 46, 48 by about 240°.

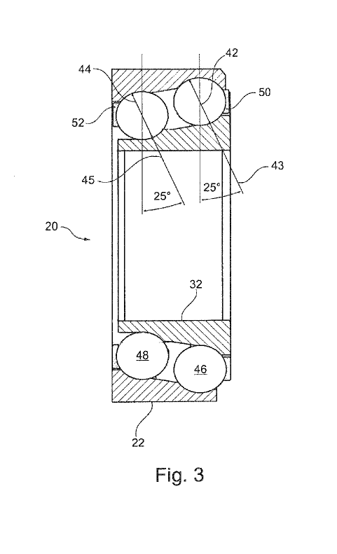

FIG. 3 illustrates one of the improvements achieved according to the present Invention in that adjacent raceways 42 and 44 adhere to each other closer together, i.e. are spaced less, such that the overall axial dimension of tandem ball bearing assembly 20 can be less than within conventional tandem roller bearings.

That allows for larger sized balls without diminishing the axial dimension of the bearing assembly thereby allowing for a higher bad carrying capacity and longer bearing life.

Additionally, by eliminating the cages stick out (or eliminating inner ribs) of the cages between the two rows from the window style cage, the axial width of the bearing assembly can be decreased and a more compact bearing design obtained.

Additionally, overall bearing costs can be reduced since the use of larger balls in the design will reduce the wall thickness of the outer ring and inner ring races and ultimately the cost of tubes and the forging used in the outer rings and the inner rings.

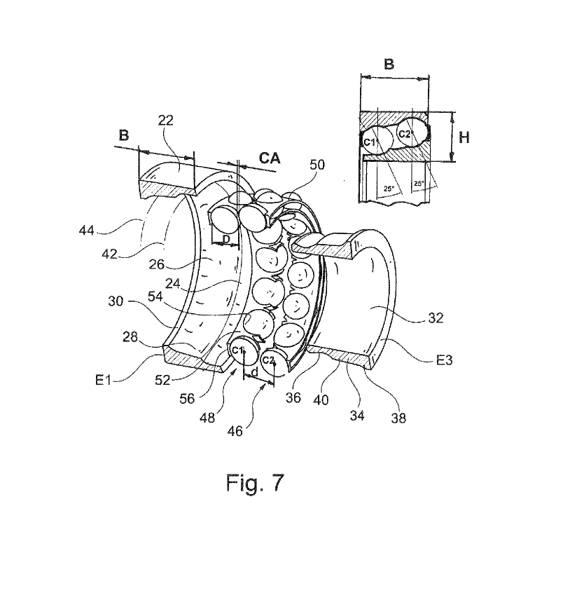

FIG. 7 illustrates a particular embodiment of the bearing according to the present invention as axial crossection and as a kind of exploded view. The bearing according to FIG. 7 is a double row, tandem, angular contact, ball bearing. This bearing includes a one piece outer bearing ring 22 having two adjacent outer races 26, 24 each of the outer races 26, 24 having a shoulder 28, 30, the shoulder 30 of one of the outer races 26 adjacent an axial edge E1 of the outer ring 22 and the shoulder 28 of the other 24 of the outer races 24, 26 is located axially inward on the outer ring 22.

The bearing further includes a one piece inner bearing ring having two adjacent inner races 36, 34, each of the inner races 36, 34 having a shoulder 40, 38, the shoulder 40 of one of the inner races 36 is located axially inward on the inner ring and the shoulder 38 of the other of the inner races 34 is located axially adjacent an edge E3 of the inner ring 32.

Upon mounting the bearing by axially fitting the shown components, one raceway 44 will be defined and formed by the one of the outer races 26 opposing the one 36 of the inner races. Another 42 raceway is formed by the other 24 of the outer races opposing the other 34 of the inner races. One set 48 of balls located in the one raceway 44, and another set 46 of balls is located in the other raceway 42.

The particular bearing assembly further includes a first cage 52 which accommodates and guides the one set 48 of balls and a second cage 50 housing the other set 46 of balls. According to the present invention, at least one of the cages 52, 50 being construed as snap cage having a plurality of thin-walled, cup shaped pockets 54 connected to one another by a rib 56, each of the pockets 54 housing one of the balls, the rib 56 of the at least one snap cage 52 is arranged adjacent one axial edge E1 of the assembly and each of the pockets 54 of the snap cage 52 open axially inward of the assembly.

In this particular embodiment, the axial distance d between the centers C1, C2 of the balls in both rows is less than 1.2 the average diameter of the balls. In this embodiment, the balls of one set 48 and the other set 46 have the same diameter.

This particular assembly is further construed in such a manner, that the minimum axial distance CA between the outer surfaces of the balls in both rows is less than 0.5 mm. Further, the axial width B of the outer ring 22 measures less than 2.2 the average diameter D of the balls.

The ratio between the overall axial width and the radial height of the bearing (B/H) is less than 1.36.

The bearing assembly as shown here may be mounted in that the balls are fitted into the pockets 54 of the cages 50, 52. Although the cages 50, 52 have a design as ball snap fitting cages, the balls may be inserted just from a radial direction, preferably from the inner side. The pockets 54 may be formed to provide a complementary spherical geometry, so as to quite stably guide the balls with merely little clearance. The inner surface of the pockets as facing the balls may have a micro-structure such as small groves or channels, designed to build up a particular lubricant film, in particular to concentrate lubricant on those areas of the balls which likely come in load carrying contact with the races upon rotation.

The completed cages 50, 52 are fitted on the inner ring 32, while the balls of the first set 48 of the balls may snugly walk into the inner race 36 after walking above a narrow front shoulder as shown in this embodiment. The thus formed subassembly may now be axially fitted into the outer ring 32.

In this mounted stage, the balls of the sets 48, 46 adhere to each other close in axial direction, and leave just a minimum axial gap of about 0.5 mm. The thus achieved bearing assembly has a considerable axial and radial load bearing capacity but requires less axial and radial space than a conventional bearing with similar load bearing capacity.

Although the present invention was illustrated in connection with an embodiment were both sets of balls are first fitted with their cages onto the inner ring and than axially fitted into the outer ring, the invention also covers those embodiments were at least one of the sets of balls is first fitted into the outer ring 22 and the inner ring is axially fitted into the preassembly either with the other set of balls sitting on the inner ring or while the other set of balls is also already seated in the outer ring.

### REFERENCE CHARACTERS

10. tandem ball bearing assembly
12. outer ring
14. inner ring
16. set of rolling elements
17. contact angles
18. cages
19. straddle window
20. tandem ball bearing assembly
22. outer ring
24. outer race
26. outer race
28. shoulder
30. shoulder
32. inner ring
34. inner race
36. inner race
38. shoulder
40. shoulder
42. raceway
43. contact angle
44. raceway
45. contact angle
46. set of balls
48. set of balls
50. snap cage
52. snap cage
54. pockets
56. rib
58. sidewalls of pocket
60. Free space
B. width of outer ring
H. radial height
C1. ball center
C2. ball center
CA. axial clearance
d. distance between ball centers
E1. axial face of outer ring
E3. axial face of inner ring
D. diameter ball

What we claim is:

1. A double row, tandem, angular contact, ball bearing assembly, comprising:
a one piece outer bearing ring having two adjacent outer races, each of the outer races having a single shoulder, the shoulder of one of the outer races adjacent an axial edge of the outer ring and the shoulder of another of the outer races axially inward on the outer ring;
a one piece inner bearing ring having two adjacent inner races, each of the inner races having a single shoulder, the shoulder of one of the inner races axially inward on the inner ring and the shoulder of another of the inner races axially adjacent an edge of the inner ring;
one raceway formed by the one of the outer races opposing the one of the inner races;
another raceway formed by the another of the outer races opposing the another of the inner races;
one set of balls located in the one raceway;
another set of balls located in the another raceway;
one snap cage housing the one set of balls and another snap cage housing the another set of balls, each of the one and another snap cage having a plurality of thin-walled, cup shaped pockets connected to one another by a single rib, each of the pockets housing one of the balls, the rib of the one cage adjacent one axial edge of the assembly and the another cage adjacent another axial edge of the assembly, and each of the pockets open axially inward of the assembly.

2. The assembly of claim 1, wherein the balls in both the one set of balls and the another set of balls have a same diameter.

3. The assembly of claim 1, wherein each pocket of the pockets in both the one cage and the another cage encircle the one of the balls housed within the pocket by about 240°.

4. A double row, tandem, angular contact, ball bearing assembly, comprising:
a one piece outer bearing ring having two adjacent outer races, each of the outer races having a shoulder, the shoulder of one of the outer races adjacent an axial edge of the outer ring and the shoulder of another of the outer races axially inward on the outer ring;
a one piece inner bearing ring having two adjacent inner races, each of the inner races having a shoulder, the shoulder of one of the inner races axially inward on the inner ring and the shoulder of another of the inner races axially adjacent an edge of the inner ring;
one raceway formed by the one of the outer races opposing the one of the inner races;
another raceway formed by the another of the outer races opposing the other of the inner races;
one set of balls located in the one raceway;
another set of balls located in the other raceway;
one cage housing the one set of balls and another cage housing the another set of balls, at least one of the cages being construed as snap cage having a plurality of thin-walled, cup shaped pockets connected to one another by a rib, each of the pockets housing one of the balls, the rib of the at least one snap cage is arranged adjacent one axial edge of the assembly and each of the pockets of the snap cage open axially inward of the assembly.

5. The assembly of claim 4, wherein an axial distance between centers of the balls in both rows is less than 1.2 an average diameter of the balls, and the one set and the another set of balls have a same diameter.

6. The assembly of claim 5, wherein a minimum axial distance between outer surfaces of the balls in both rows is less than 0.5 mm.

7. The assembly of claim 4, wherein an axial width of the outer ring is less than 2.2 an average diameter of the balls.

8. The assembly of claim 4, wherein a ratio between an overall axial width and a radial height of the bearing (B/H) is less than 1.36.

9. The assembly of claim 4, wherein an inner diameter of the inner shoulder of the outer ring is smaller than a maximum diameter of both of the outer races.

10. The assembly of claim 4, wherein an outer diameter of the inner shoulder of the inner ring is larger than a minimum diameter of both of the inner races.
